(19) United States
(12) Patent Application Publication
(10) Pub. No.: US 2017/0059703 A1
(43) Pub. Date: Mar. 2, 2017

(54) SYSTEM FOR USE IN A VEHICLE

(71) Applicant: Jaguar Land Rover Limited, Coventry. Warwickshire (GB)

(72) Inventors: Edward Hoare, Malvern (GB); Thuy-Yung Tran, Rugby (GB); Marina Gashinova, Birmingham (GB); Aleksandr Bystrov, Birmingham (GB); Mikhail Cherniakov, Birmingham (GB)

(21) Appl. No.: 15/118,656

(22) PCT Filed: Feb. 4, 2015
(86) PCT No.: PCT/EP2015/052289

§ 371 Date: Aug. 12, 2016

(30) Foreign Application Priority Data
Feb. 12, 2014 (GB) 1402397.2

(51) Int. Cl. G01S 13/93; G01S 13/04; G01S 13/94; G01S 13/86; G01S 13/89

(52) U.S. Cl. CPC G01S 13/931; G01S 13/862; G01S 13/89; G01S 13/94; G01S 13/04; G01S 2013/9375

(57) ABSTRACT

The invention provides a system method and vehicle for profiling the terrain ahead of a vehicle. The system comprises receiving means configured to receive sensor output data from a plurality of vehicle-mounted sensors, including at least one radar sensor and at least one acoustic sensor, each for receiving a reflected signal from the terrain ahead of the vehicle. A determining means is configured to determine at least one parameter from the sensor output data for the at least one radar sensor and the at least one acoustic sensor, and an image generation means is configured to generate an image of the terrain ahead of the vehicle based on the at least one parameter from the at least one radar sensor. A processing means enhances the clarity of the image based on the at least one parameter from the at least one acoustic sensor.

### FIELD OF THE INVENTION

The present invention relates to a system for use in a vehicle that profiles the terrain ahead of the vehicle and, in particular, enables the detection of obstacles such as debris, dips, troughs, potholes or sleeping policemen in the path ahead of the vehicle. Aspects of the invention relate to a system, to a method, and to a vehicle itself.

### BACKGROUND

Many modern vehicles are fitted with systems (anti-lock braking, adjustable ride height etc.) designed to improve the riding experience of the users. The riding experience could be a measure of safety, comfort, or something else, and the setup of the systems of a vehicle to optimise the riding experience is dependent on the type of terrain over which the vehicle travels. Current systems with defined system settings for a plurality of different terrain types use sensors to determine characteristics about the terrain over which a vehicle is travelling and then select the most appropriate setting.

It is also desirable on the vehicle to be able to predict in advance not only the type of terrain that the vehicle is travelling over, or approaching, but whether there are obstructions in the likely path of the vehicle which, if they are encountered, may cause damage to the vehicle or undue discomfort to the users. Debris such as general rubbish or detached car parts can be commonplace on highways and other roadways. Potholes are another type of common obstruction. If a vehicle encounters debris or potholes that are not anticipated, damage can be done to the vehicle, as well as to the vehicle contents, and the users may experience an uncomfortable jolt as the vehicle impacts the obstruction.

There are a variety of current techniques for determining the profile of the terrain ahead of a vehicle and for detecting an obstruction in the likely path of the vehicle: infrared sensors detect infrared radiation being emitted from the surface ahead of the vehicle and optical sensors scan the surface ahead for characteristics relating to certain terrain types and for obstructions in the vehicle's path. However, both suffer from the disadvantage of being short-range and being unreliable in certain weather conditions.

One aim of the invention is to provide a system and method for use on a vehicle in determining the presence and location of an obstruction such as a pothole in the path ahead of the vehicle, whilst addressing the disadvantages of the systems in the prior art.

### STATEMENT OF THE INVENTION

According to an aspect of the invention there is provided a system for use in a vehicle for profiling the terrain ahead of the vehicle, the system comprising receiving means configured to receive sensor output data from a plurality of vehicle-mounted sensors, including at least one radar sensor and at least one acoustic sensor, each for receiving a reflected signal from the terrain ahead of the vehicle. The system also includes determining means configured to determine at least one parameter from the sensor output data for the at least one radar sensor and the at least one acoustic sensor. The system further includes image generation means configured to generate an image of the terrain ahead of the vehicle based on the at least one parameter from the at least one radar sensor, and processing means configured to enhance the clarity of the image based on the at least one parameter from the at least one acoustic sensor.

In the context of the present invention, “vehicle-mounted” may refer to a portable device which is carried on the vehicle temporarily or may refer to a permanent fixture of the vehicle, for example one which is present on the vehicle for other purpose also. The combination of sensor output data from both a radar sensor and an acoustic sensor can result in a more accurate profiling of the terrain ahead of the vehicle. In particular, a radar sensor may be used to generate an image of the terrain at long range and the acoustic sensor may be used to enhance the clarity of this image at short range.

In one embodiment, the receiving means comprises means configured to receive frequency-domain sensor output data from the at least one radar sensor.

In addition, the determining means may include conversion means configured to convert the frequency-domain sensor output data into time-dependent, and/or spatially-varying, power magnitude sensor output data. For example, the conversion means may include an inverse Fourier Transform algorithm.

The image generation means may be configured to generate the image based on the determined power magnitude.

The system may comprise first compensation means configured to compensate the image to account for power magnitude loss in the sensor output data, and/or second compensation means configured to compensate the image to remove background noise in the sensor output data from the at least one radar sensor.

For example, the system may further comprise means for comparing the determined power magnitude with a minimum threshold value for the power magnitude and for removing from the image sensor output data having a determined power magnitude that is below the minimum threshold value (i.e. thereby removing data that is background noise).

Image processing of the type mentioned above can help to increase the accuracy and the clarity of the image of the terrain, and increase the possibility of extracting particular features such as obstacles or potholes in the image of the terrain.

In one embodiment, the system comprises means configured to communicate the image to the user. This may be in the form of a human machine interface including, for example, a visual display and/or an audio system. This allows the user to take the appropriate action on the basis of the information contained in the image (for example, by altering the speed of the vehicle).

The system may comprise processing means configured to detect the presence of an obstruction in the image, and may further comprise processing means for detecting the location of the obstruction with respect to the vehicle. The system may comprise means configured to alert the user to the presence of, and/or the location of, the obstruction ahead of the vehicle, and this may comprise at least one of visual and audio means. This will allow the user to prepare the vehicle in the most appropriate way to best negotiate the obstruction (for example, to take avoidance action).

The system may further comprise means for transmitting radar and/or acoustic signals at a plurality of different angles with respect to the direction in which the vehicle is travelling. In this way, sensor output data corresponding to a wide range of the terrain in both the lateral and longitudinal directions with respect to the direction in which the vehicle is travelling is included in the generated image so as to provide a more complete image of the terrain ahead of the vehicle.

In one embodiment, the system comprises at least one radar sensor and at least one acoustic sensor. The system may further comprise means configured to move angularly the at least one radar sensor and/or the at least one acoustic sensor about its axis with respect to the direction in which the vehicle is travelling so as to permit sensor data corresponding to a wide range of the terrain, in both the lateral and longitudinal directions with respect to the direction in which the vehicle is travelling, to be included in the generated image.

According to another aspect of the invention, there is provided a method for implementing the system capabilities described above to enable the system to profile the terrain ahead of the vehicle.

According to another aspect of the invention, there is provided a vehicle comprising a vehicle control system as described above, at least one radar sensor, and at least one acoustic sensor.

Other features of the invention will be apparent from the appended claims.

Within the scope of this application it is expressly envisaged that the various aspects, embodiments, examples and alternatives set out in the preceding paragraphs, in the claims and/or in the following description and drawings, and in particular the individual features thereof, may be taken independently or in any combination. For example, features disclosed in connection with one embodiment are applicable to all embodiments, except where such features are incompatible.

### BRIEF DESCRIPTION OF DRAWINGS

The invention will now be described, by way of example only, with reference to the accompanying figures in which:

FIG. 1 is a plan view of a vehicle and of terrain ahead of the vehicle, and showing sensors on the vehicle for use in profiling the terrain ahead of the vehicle;

FIG. 2 is a diagram showing the component parts of a vehicle control system (VCS), together with the inputs to, and outputs from, the VCS;

FIG. 3 is a diagram showing a radar sensor of the vehicle in FIG. 1 and means configured to process output signals from this sensor;

FIG. 4 is a diagram showing a “footprint” of the area of the terrain ahead of the vehicle in FIG. 1 from which backscattered radar signals are received by the radar sensor in FIG. 3 for a plurality of azimuthal angles with respect to the direction in which the vehicle is travelling;

FIG. 5 is diagram showing an acoustic sensor of the vehicle in FIG. 1 and means configured to process output signals from this sensor;

FIG. 6 is a flow diagram which illustrates a process according to an embodiment of the invention for generating an image of the terrain ahead of the vehicle in FIG. 1 and, in particular, for detecting and locating obstructions in the vehicle's path;

FIG. 7 is a diagram showing various obstructions ahead of the vehicle in FIG. 1, and the lateral and longitudinal distances from the vehicle to each obstruction;

FIG. 8 is an image of the power magnitude of the sensor output data from the radar sensor in FIG. 3 received from a terrain containing the obstructions shown in FIG. 7;

FIG. 9 is a compensated image corresponding to that shown in FIG. 8 after background noise has been removed;

FIG. 10 is a compensated image corresponding to that shown in FIG. 9 after compensating for the differences in power magnitude of the sensor output data from the radar sensor in FIG. 3 over a range of distances; and

FIG. 11 is an alternative compensated image corresponding to that shown in FIG. 10 after the power magnitude of the sensor output data from the radar sensor in FIG. 3 below a minimum threshold value has been removed.

### DETAILED DESCRIPTION

In one embodiment of the present invention, the power magnitude of sensor output data from backscattered signals relating to the terrain ahead of a vehicle, that are transmitted from a plurality of different types of sensor, is used to generate an image of the terrain ahead of the vehicle and, in particular, to detect and locate obstructions in the vehicle's path.

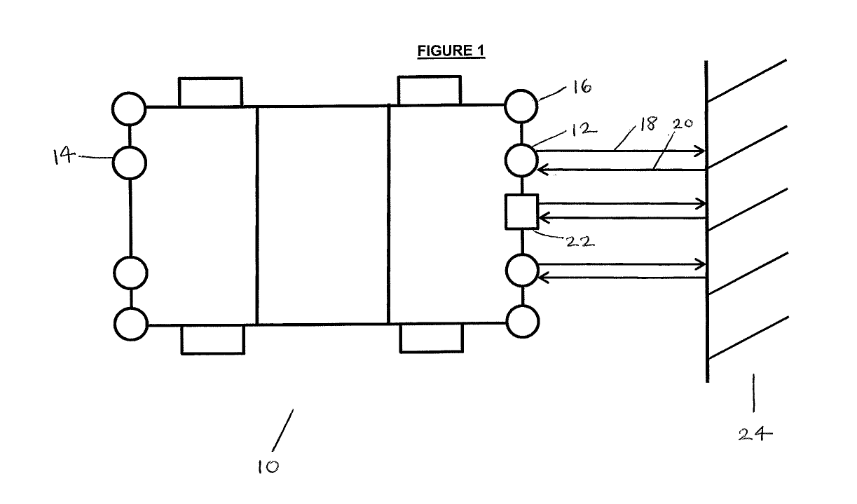

FIG. 1 shows one embodiment of a vehicle 10 with two different types of sensors that collect data to be input to different systems of the vehicle. In current systems, there may be acoustic sensors positioned at the front 12, rear 14 and/or side 16 of the vehicle: commonly, acoustic sensors are used to send and receive acoustic signals to collect sensor output data to be input to, for example, parking assistance systems of the vehicle.

Typically, parking assistance systems are used to warn a vehicle user, either by visual or audible means, of the vehicle's proximity to an obstacle such as a wall or another vehicle. In the case of an audible warning, a warning tone may sound with increasing frequency as the obstacle becomes closer to the vehicle. The acoustic sensors used for parking assistance systems are typically able to detect obstacles at short-range (0.25-1.5 metres) but at a wide angle from the direction in which the sensor is pointed. The parking assistance system may transmit acoustic pulses 18 (typically 51 Hertz) and then receive back any reflected signal 20 from an obstacle, which may then be processed to calculate the distance between the vehicle and the obstacle.

Also in current systems, there may be a radar sensor 22 positioned at the front of the vehicle: commonly, radar sensors are used to send and receive radar signals to collect and receive data to be input to, for example, adaptive cruise control (ACC) systems. In an ACC system, the time between a radar signal being sent and then received back is measured, and then the distance to a vehicle in front is calculated. This information is sent to other systems of the vehicle (throttle control, brake control etc.) and the necessary action is taken to maintain a constant distance to the vehicle in front. The radar sensors in an ACC system are typically able to detect an obstacle up to about 150 metres in front of the vehicle but at a narrow angle from the direction in which the sensor is pointed; other ACC systems may use shorter range, wider angle radars, or a combination of both.

Radar sensors may be positioned at other locations on the vehicle to collect data to be input to, for example, blind spot detection (BSD) systems, lane departure warning systems, or speed-gun detector systems. FIG. 1 also shows the terrain 24 ahead of the vehicle.

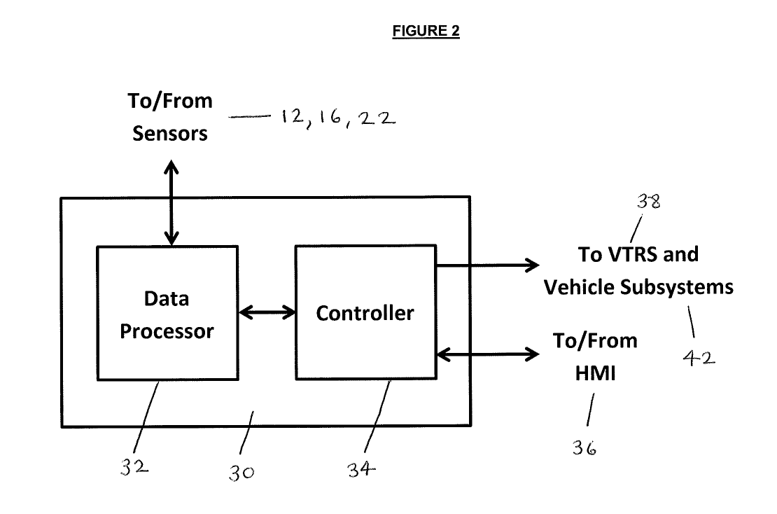

Referring to FIG. 2, in current vehicles a vehicle control system (VCS) 30 may include a data processor 32 and a controller 34 for controlling various vehicle systems. The controller 34 communicates with a human machine interface (HMI) 36 which incorporates a display. Via the HMI display, the user receives alerts or advice, relating to a host of vehicle systems, for example, satellite navigation or in-vehicle entertainment systems. The HMI 36 typically includes a touch-screen keyboard, dial, or voice activation to enable user selection of a particular input for the various vehicle systems which can be controlled.

In some vehicles a separate VCS is configured to improve the riding experience of the vehicle user: for example, a vehicle system in the form of a vehicle terrain response system 38 (VTRS, such as a Terrain Response® system) receives sensor output data from one or more sensors (such as a wheel speed sensor, tyre pressure sensor, vehicle speed sensor, brake pedal position sensor, suspension articulation, acceleration, wheel slip, pitch rate, and yaw rate) relating to the terrain in the vicinity of the vehicle, processes the data, and sends control signals via a controller to one or more subsystems 42 (such as a suspension system, traction-control system, stability-control system, engine torque system, or ride height system) so as to allow adjustment of the setup of the vehicle 10 accordingly. Adjustment of the vehicle setup may be automatic in response to the sensor signals, or may be user-initiated following prompts from the VTRS 38.

In a vehicle incorporating a VTRS 38, in response to a user-input via the HMI 36, a control signal is sent via the controller 34 of the VCS 30 to one or more vehicle subsystems 42 to adjust the vehicle setup, according to the terrain type in the vicinity of the vehicle 10.

The VCS 30 may also send alerts to the vehicle user, via the HMI 36, to adjust his/her driving style (for example, to reduce the vehicle speed), according to the terrain type in the vicinity of the vehicle 10.

In addition to the VTRS 38 adjusting the vehicle setup, and/or the HMI 36 alerting the user, according to the terrain type in the vicinity of the vehicle 10, it is desirable that obstructions (such as potholes or sleeping policemen) in the path ahead of the vehicle 10 are detected and located so that the VTRS 38 can adjust the vehicle setup, and/or the HMI 36 can alert the user, accordingly.

In one embodiment, one or more radar sensors from an ACC system are adjusted to transmit and receive radar signals to be used to detect and locate obstructions in the path ahead of the vehicle 10. Radar signals are typically transmitted and received at a plurality of discrete frequencies; however, for example, in the automotive industry the licensed band for short-range radars is restricted to 21.65-26.65 GHz and 76-81 GHz.

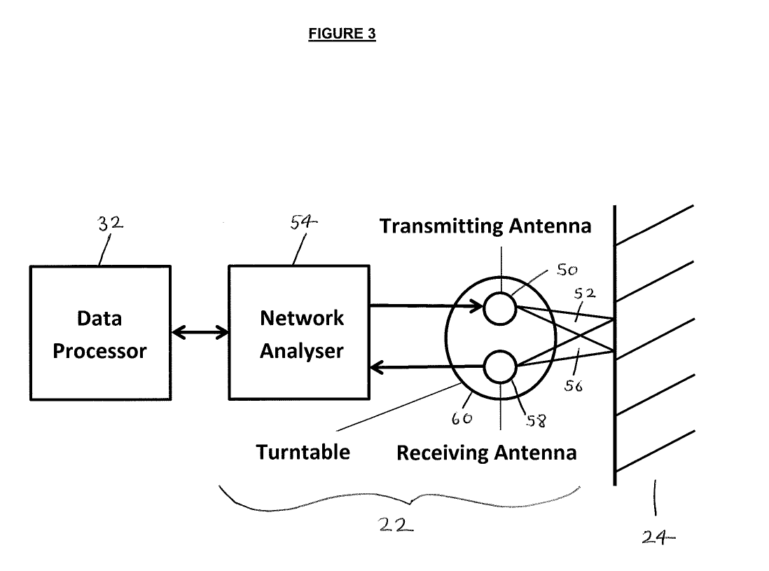

FIG. 3 shows a radar sensor 22 of the vehicle in FIG. 1 and a data processor 32 configured to process sensor output data from the radar sensor 22. In particular, FIG. 3 shows a transmitting antenna 50 mounted at the front of the vehicle, angled towards the terrain 24, and configured to transmit a radar signal 52, generated by a Network Analyser 54, to the terrain 24 ahead. Note that a Network Analyser may be used in this experimental stage only, and that dedicated hardware sensors will be used in the on-board vehicle implementation for the purpose of generating the radar signals. The radar signal 52 is reflected from the terrain 24 and a reflected or backscattered signal 56 is received by a receiving antenna 58. The amplitude of the backscattered signal 56 is recorded by the Network Analyser 54 and is processed by the data processor 32 to obtain the power magnitude of the backscattered signal 56. The time it takes for the backscattered signal 56 to be received by the receiving antenna 58 may be used to determine the distance ahead of the vehicle 10 to which the backscattered signal 56 relates.

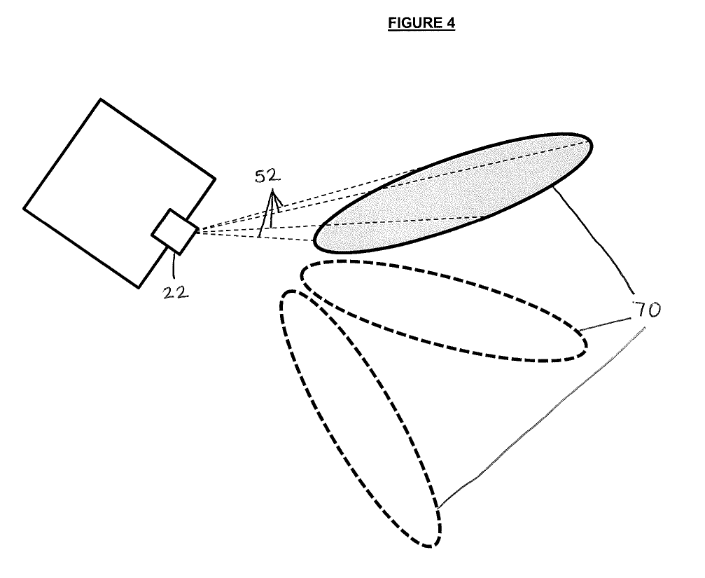

The radar sensor 22 is positioned on an angularly adjustable support such as a turntable 60 that rotates about its axis to allow radar signals to be transmitted at various azimuthal angles with respect to the direction in which the vehicle 10 is travelling. In particular, FIG. 4 shows a radar sensor 22 that transmits a radar signal 52 to provide a so-called “footprint” 70 of the terrain 24. A relatively narrow signal beam in the azimuthal direction and a relatively small angle of incidence towards the terrain 24 provides a relatively large footprint 70 from which the transmitted signal 52 is scattered back towards the radar sensor 22. In this way, the radar sensor 22 receives backscattered signals 56 relating to a relatively large area of terrain 24 ahead of the vehicle 10. The radar sensor 22 moves angularly on the turntable 60 and transmits signals 52 at a plurality of different azimuthal angles so that obstructions in a wide range of azimuthal directions ahead of the vehicle 10 are detected.

In addition to the one or more radar sensors 22 from an ACC system, one or more acoustic sensors 12, 16 from the parking assistance system could be used to collect data relating to the terrain 24 ahead of the vehicle 10. The acoustic sensors 12, 16 are mounted on the vehicle 10 in a similar manner as for the radar sensors 22, namely on an angularly adjustable support such as a turntable 60.

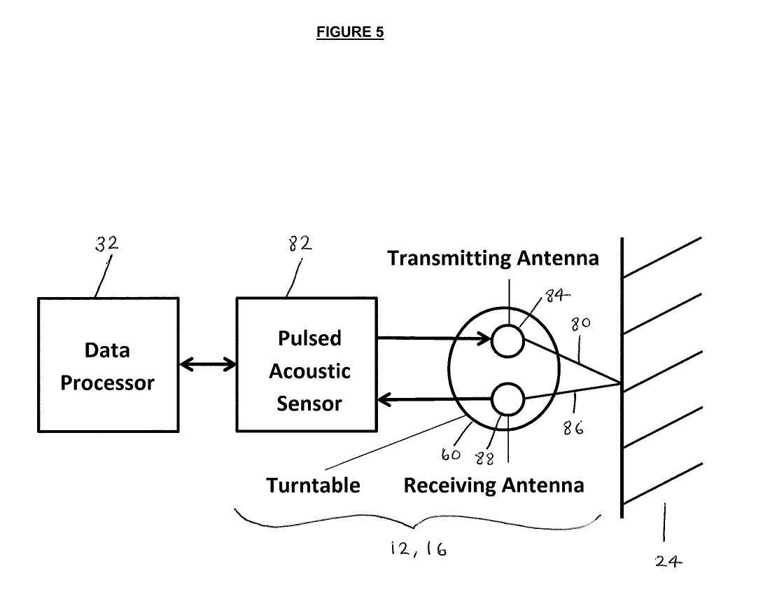

An acoustic sensor 12, 16 may be used to characterise, for example, the roughness, texture, or sound absorption of a given type of terrain. Referring to FIG. 5, in one embodiment a pulsed acoustic sensor 82 transmits an acoustic signal 80 through a transmitting antenna 84. The transmitted signal is reflected from the terrain ahead of the vehicle and a reflected or backscattered signal 86 is received by a receiving antenna 88 and is measured for energy, duration, range and/or another property of the signal by the pulsed acoustic sensor 82. The received signal 86 is processed by the data processor 32 to, for example, appropriately scale the signal, to account for path loss, to average the signal in time, and/or to compare against signals in different conditions (such as different weather conditions).

The collected data from the radar sensors 22 is used to generate an image of the terrain 24 ahead of the vehicle 10, including any obstructions in the vehicle's path. The collected data from the acoustic sensors 12, 16 is then used to enhance the clarity of the determined size and location of any obstructions that have been detected using the radar sensors 22. The detection of obstructions in the vehicle's path is therefore a two-stage process involving two different types of sensor, the radar sensors 22 and the acoustic sensors 12, 16. Once an obstruction has been detected and located with respect to the vehicle, the driver is alerted to the obstruction via the HMI 36, as shown in FIG. 2, either through an audible or a visual alert. The VTRS 38 may also be updated with this information so that adjustments can be made, if appropriate, to various vehicle settings in order to navigate or pass over the detected obstruction.

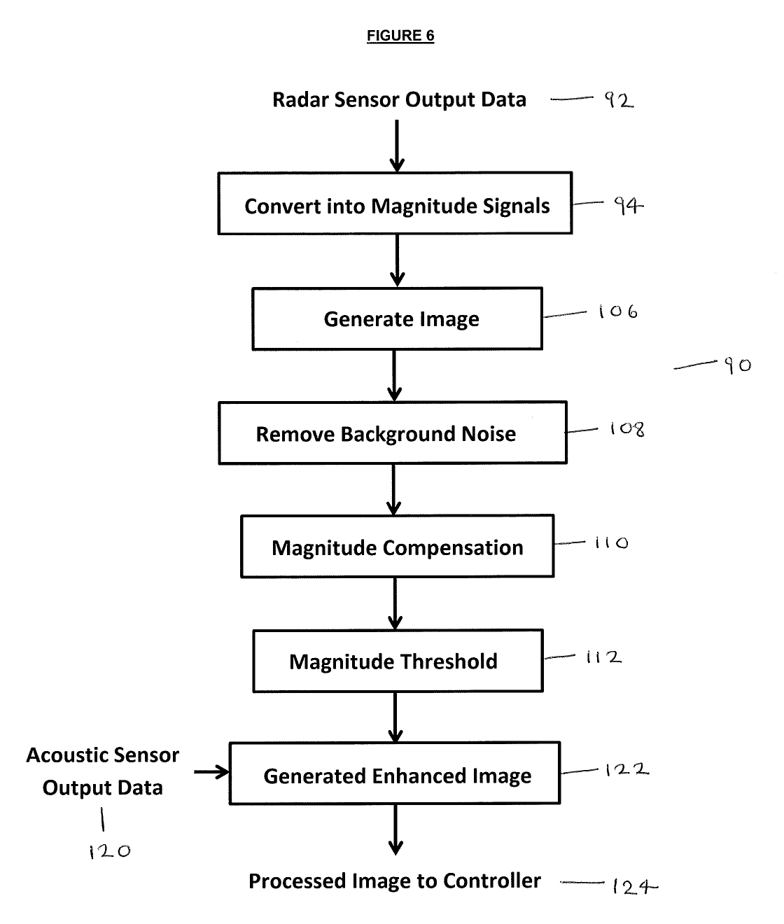

FIG. 6 shows a process 90 that is undertaken by the data processor 32 to generate the image of the terrain 24. In particular, radar sensor output data 92 collected from the sensors 22 is converted from Frequency Domain (FD) data into Time Domain (TD) data in the form of intensity or magnitude signals at step 94, for each different azimuthal angle for which a radar signal is transmitted 52. The well-known Inverse Fourier Transform (IFT) may be used to perform this conversion. Essentially this means that data relating to the received radar signal 56 that is recorded by the Network Analyser 54 may be processed (using the IFT) to reconstruct the original received signal (wave) and, in particular, the magnitude of the signal at each point in time or space.

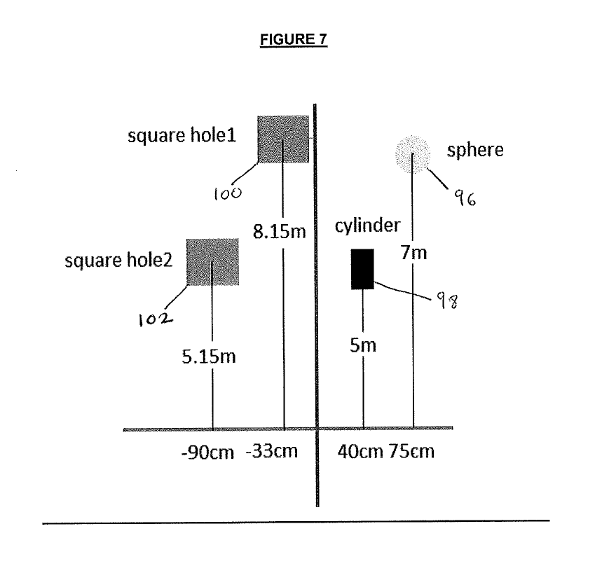

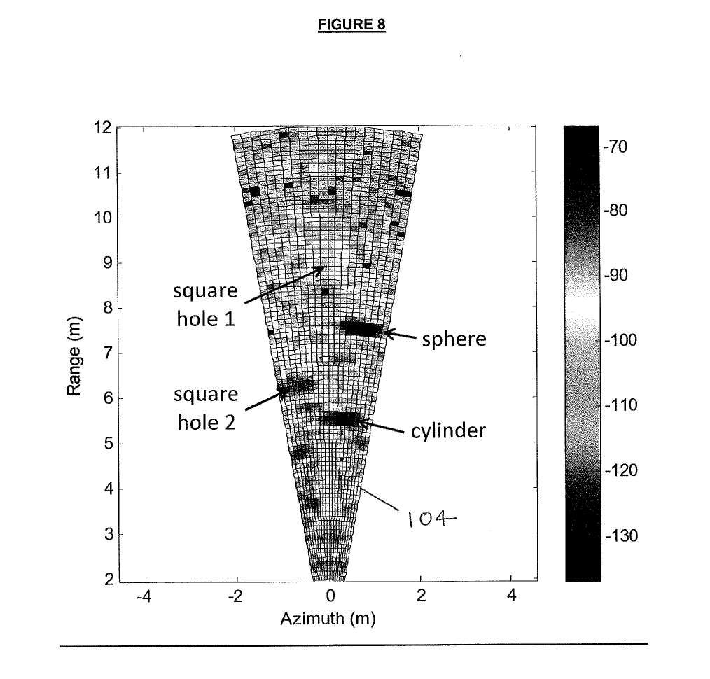

FIG. 7 shows an example of a layout of possible obstructions in the vehicle's path, including the lateral and longitudinal distances from the vehicle. In this particular case, the sphere 96 has a diameter of 0.32 metres, the cylinder 98 has a diameter of 0.132 metres, and both of the square holes 100, 102 have a width of 0.66 metres. FIG. 8 then shows the image 104, plotted using polar coordinates, that is generated at step 106 in FIG. 4 of such a layout, using the TD magnitude signals from step 94. In this particular case, a transmitted radar signal frequency of 29.75-31.25 GHz is used and twenty one radar signals are transmitted at one degree intervals of the azimuthal angle, ranging from minus ten to plus ten degrees with respect to the direction in which the vehicle 10 is travelling. All four of the abovementioned objects are visible in the image 104.

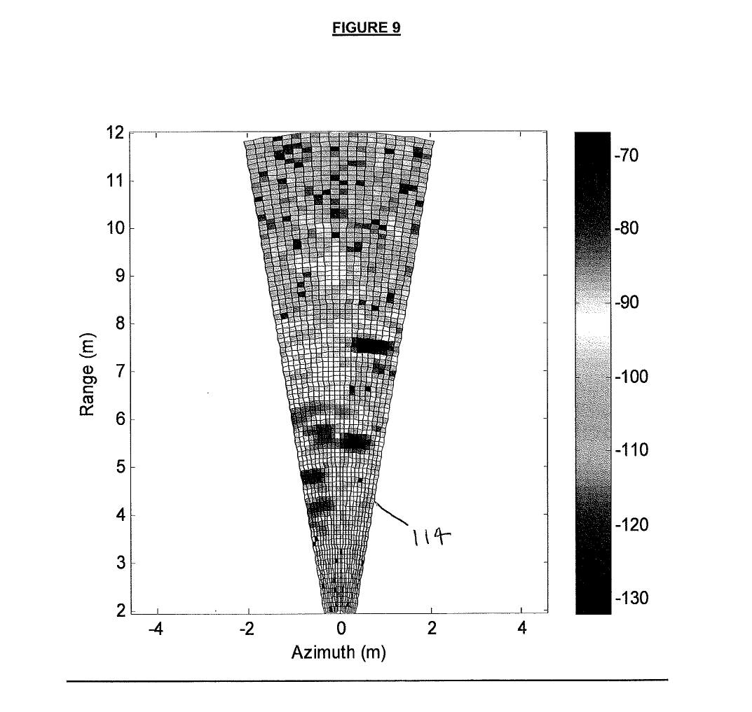

The image 104 is then processed at steps 108, 110 and 112 to enhance the clarity of the detected obstructions in the image 104. In particular, a degree of noise is to be expected in any received signal and so at step 108, this noise is removed from the background of the image 104, for example using an average background image, a fixed or adaptive noise threshold, or a constant false alarm rate threshold, and this gives the updated image 114 shown in FIG. 9.

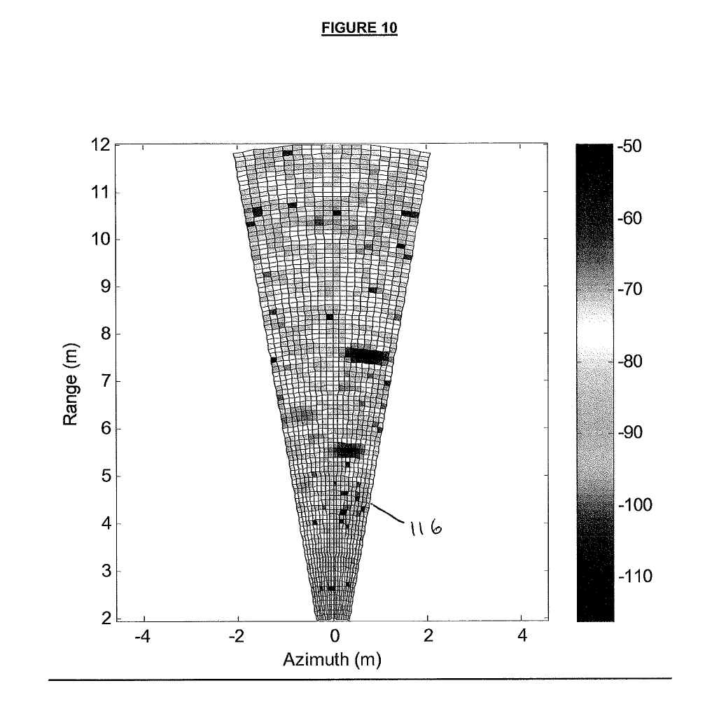

The greater the distance that a backscattered signal 56 travels to the receiving antenna 58, the greater the amount of power that will be transferred to the surroundings before the signal is received, thus resulting in a lower signal magnitude. This means that smaller obstructions that are relatively close to the receiving antenna 58 may have the same level of power magnitude as larger obstructions that are relatively far from the receiving antenna 58. For example, despite the fact that square holes 100, 102 in FIG. 7 are the same diameter, square hole 2 (labelled 102) is shown more clearly in FIGS. 8 and 9 because it is closer to the receiving antenna 58. Therefore, the image 114 is processed at step 110 to account for this power magnitude loss at greater distances from the receiving antenna 58 to produce the image 116 shown in FIG. 10. This may be, for example, achieved by scaling the power magnitude data at Range ̂⁴ (R² out and R² return).

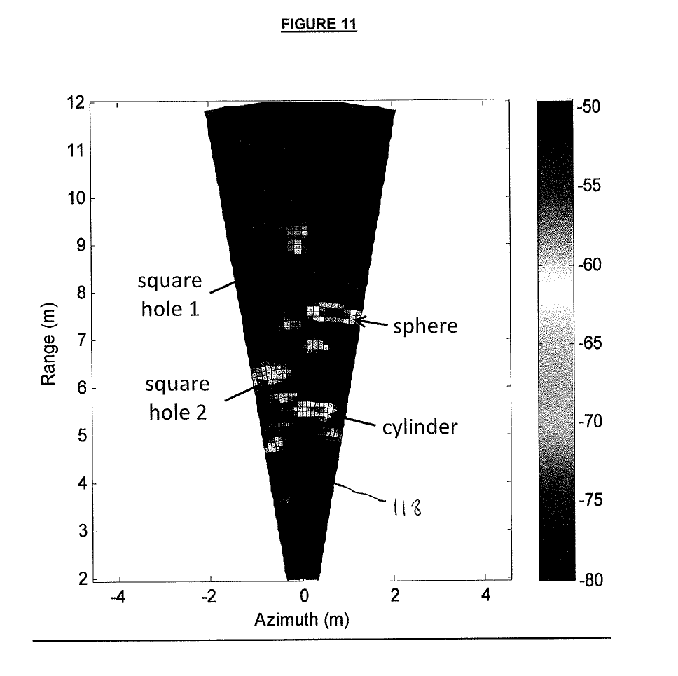

For the purposes of the present invention, relatively small obstructions that have no bearing on the comfort or safety of the vehicle users are not required to be detected because the user does not need to be informed of such obstructions, and the setup of the vehicle 10 does not require to be altered via the VTRS 38 because of such obstructions. Therefore, at step 112, any backscattered signals 56 below a minimum threshold value (corresponding to obstructions with dimensions below a minimum threshold) are removed from the image 116 to produce the image 118 shown in FIG. 11. In this particular case, the minimum threshold value is −90 dB. It is seen that the four objects shown in FIG. 7 are clearer after the processing steps 108, 110 and 112 in image 118 shown in FIG. 11 compared with the raw image 104 shown in FIG. 8.

Despite the use of image processing as described above, the resolution of a received radar signal is limited by its transmitted bandwidth; however, an image of the terrain 24 over a relatively long range (up to 150 metres, as mentioned above) may be generated with reasonable accuracy by using the radar signal. In one embodiment, acoustic sensor output data 120 from one or more acoustic sensors 12, 16 may be used to enhance the accuracy of the generated size and location of the obstructions in the path ahead of the vehicle 10. Acoustic sensors provide better resolution than radar sensors but are, in general, limited to use over a shorter range. At step 122, the detected obstructions in image 118 shown in FIG. 11 that are within the range of the acoustic sensor 12, 16 are analysed using the acoustic sensor output data 120 and an updated image containing the refined obstructions is sent to the controller 34 at step 124. The radar data is used to determine which areas the acoustic sensors need to interrogate in greater detail once they become within range of the acoustic sensors.

The controller 34 then communicates with the HMI 36 and the image of the terrain 24 ahead of the vehicle 10 with the detected obstructions may be shown to the user by visual means and/or the user may be warned to adjust his/her driving (for example, by reducing the speed of the vehicle or by taking avoidance action) to negotiate the obstruction. In addition, or alternatively, the controller 34 may communicate with the VTRS 38 to adjust the setup of the vehicle so as to best negotiate the obstruction (for example, to adjust the suspension if the vehicle is approaching a pothole).

In one embodiment, the present invention has the advantage of simply requiring existing systems on a vehicle to be modified (for example, parking assistance and ACC systems), and so the present invention doesn't incur additional cost to the user and does not require extra equipment that may add extra weight or take up more space in a vehicle.

It is to be understood that the controller or controllers described herein can comprise a control unit or computational device having one or more electronic processors. The system may comprise a single control unit or electronic controller or alternatively different functions of the controller may be embodied in, or hosted in, different control units or controllers. As used herein the term “control unit” will be understood to include both a single control unit or controller and a plurality of control units or controllers collectively operating to provide the stated control functionality. A set of instructions could be provided which, when executed, cause said computational device to implement the control techniques described herein. The set of instructions could be embedded in said one or more electronic processors. Alternatively, the set of instructions could be provided as software to be executed on said computational device. The controller may be implemented in software run on one or more processors. One or more other controllers may be implemented in software run on one or more processors, optionally the same one or more processors as the first controller. Furthermore, the term processor as used herein may refer to a single processor or a plurality of processors configured to communicate with one another to perform one or more control or processing functions.

It will be appreciated by a person skilled in the art that the invention could be modified to take many alternative forms without departing from the scope of the appended claims.

Further aspects of the present invention are set out in the following numbered Clauses:
Clause 1. A terrain profiling system to profile the terrain ahead of a vehicle, the system comprising:
   at least one receiver that receives sensor output data from a plurality of vehicle-mounted sensors, said plurality of vehicle-mounted sensors including at least one radar sensor and at least one acoustic sensor, each said radar sensor and acoustic sensor for receiving a reflected signal from the terrain ahead of the vehicle;
   one or more processor that determines at least one parameter from the sensor output data for said at least one radar sensor and the at least one acoustic sensor;
   an image generator that generates an image of the terrain ahead of the vehicle based on said at least one parameter from said at least one radar sensor; and wherein
   said one or more processor enhances the clarity of the image based on said at least one parameter from said at least one acoustic sensor.
Clause 2. A system according to clause 1, wherein the receiver is configured to receive frequency-domain sensor output data from said at least one radar sensor.
Clause 3. A system according to clause 2, wherein said one or more processors includes a converter to convert said frequency-domain sensor output data into time-dependent, and/or spatially-varying, power magnitude sensor output data.
Clause 4. A system according to clause 3, wherein the convertor performs an inverse Fourier Transform algorithm.
Clause 5. A system according to clause 4, wherein the image generation means is configured to generate the image based on the determined power magnitude.
Clause 6. A system as claimed in clause 5, wherein the processor compensates said image to account for power magnitude loss in said sensor output data from said at least one radar sensor.
Clause 7. A system according to clause 6, wherein the processor further compensates said image to remove background noise in said sensor output data from said at least one radar sensor.
Clause 8. A system according to clause 7, wherein the processor compares said determined power magnitude with a minimum threshold value for the power magnitude and removes from said image sensor output data having a determined power magnitude that is below said minimum threshold value.
Clause 9. A system according to clause 1, comprising a display means to communicate the image to a user.
Clause 10. A system according to clause 1, wherein said at least one processor detects the presence of an obstruction in the image.
Clause 11. A system according to clause 10, wherein said at least one processor detects the location of the obstruction with respect to the vehicle.
Clause 12. A system according to clause 10, wherein said at least one processor is configured to alert the user to the presence of, and/or the location of, said obstruction ahead of said vehicle.
Clause 13. A system according to clause 12, comprising at least one of visual and audio means configured to alert the user to the presence of, and/or the location of, said obstruction ahead of the vehicle.
Clause 14. A system according to any of clause 1, wherein at least one of said at least one radar sensor and said at least one acoustic sensor is configured to move angularly about its axis with respect to the direction in which the vehicle is travelling.
Clause 15. A system according to clause 14, wherein said at least one radar sensor and/or said at least one acoustic sensor transmits signals at a plurality of different azimuthal angles with respect to the direction in which the vehicle is travelling.
Clause 16. A method for use in a vehicle for profiling the terrain ahead of the vehicle, the method comprising:
   receiving sensor output data from a plurality of vehicle-mounted sensors, including at least one radar sensor and at least one acoustic sensor receiving a reflected signal from the terrain ahead of the vehicle;
   determining at least one parameter from the sensor output data for the at least one radar sensor and the at least one acoustic sensor;
   generating an image of the terrain ahead of the vehicle based on the at least one parameter from the at least one radar sensor; and
   enhancing the clarity of the image based on the at least one parameter from the at least one acoustic sensor.
Clause 17. A memory means containing a computer readable code for performing the method according to clause 16.
Clause 18 A vehicle comprising a system as claimed in clause, including at least one radar transmitting antenna for transmitting an radar signal to the terrain ahead and at least one radar receiving antenna for receiving a reflected signal of the radar signal from the terrain ahead, and at least one acoustic transmitter for transmitting an acoustic signal to the terrain ahead and at least one acoustic receiver for receiving a reflected signal of the acoustic signal from the terrain ahead.

1. A system for use in a vehicle for profiling the terrain ahead of the vehicle, the system comprising:
a receiver configured to receive sensor output data from a plurality of vehicle-mounted sensors, including at least one radar sensor and at least one acoustic sensor, each for receiving a reflected signal from the terrain ahead of the vehicle;
a determiner configured to determine at least one parameter from the sensor output data for the at least one radar sensor and the at least one acoustic sensor;
an image generator configured to generate an image of the terrain ahead of the vehicle based on the at least one parameter from the at least one radar sensor; and
a processor configured to enhance the clarity of the image of the terrain ahead of the vehicle, based on the at least one parameter from the at least one acoustic sensor wherein the sensor output data for the at least one radar sensor is used to determine which areas of the terrain ahead of the vehicle the acoustic sensors need to interrogate in greater detail once they become within range of the acoustic sensors.

2. A system according to claim 1, wherein the receiver comprises means configured to receive frequency-domain sensor output data from the at least one radar sensor.

3. A system according to claim 2, wherein the determiner includes a converter configured to convert the frequency-domain sensor output data into time-dependent, and/or spatially-varying, power magnitude sensor output data.

4. A system according to claim 3, wherein the converter includes an inverse Fourier Transform algorithm.

5. A system according to claim 4, wherein the image generator is configured to generate the image based on the determined power magnitude.

6. A system as claimed in claim 5, comprising a first compensator configured to compensate the image to account for power magnitude loss in the sensor output data from the at least one radar sensor.

7. A system according to claim 6, comprising a second compensator configured to compensate the image to remove background noise in the sensor output data from the at least one radar sensor.

8. A system according to claim 7, wherein the second compensator includes means for comparing the determined power magnitude with a minimum threshold value for the power magnitude and for removing from the image sensor output data having a determined power magnitude that is below the minimum threshold value.

9. A system according to claim 1, comprising means configured to communicate the image to the user.

10. A system according to claim 1, wherein the processor comprises a detector configured to detect the presence of an obstruction in the image.

11. A system according to claim 10 wherein the processor comprises means for detecting the location of the obstruction with respect to the vehicle.

12. A system according to claim 10, wherein the processor comprises means configured to alert the user to the presence of, and/or the location of, the obstruction ahead of the vehicle.

13. A system according to claim 12, comprising at least one of visual and audio means configured to alert the user to the presence of, and/or the location of, the obstruction ahead of the vehicle.

14. A system according to claim 1, comprising the at least one radar sensor and the at least one acoustic sensor and means configured to move angularly, the at least one radar sensor and/or the at least one acoustic sensor about its axis with respect to the direction in which the vehicle is travelling.

15. A system according to claim 14, wherein the at least one radar sensor and/or the at least one acoustic sensor transmits signals at a plurality of different azimuthal angles with respect to the direction in which the vehicle is travelling.

16. A method for use in a vehicle for profiling the terrain ahead of the vehicle, the method comprising:
receiving sensor output data from a plurality of vehicle-mounted sensors, including at least one radar sensor and at least one acoustic sensor receiving a reflected signal from the terrain ahead of the vehicle;
determining at least one parameter from the sensor output data for the at least one radar sensor and the at least one acoustic sensor;
generating an image of the terrain ahead of the vehicle based on the at least one parameter from the at least one radar sensor; and
enhancing the clarity of the image based on the at least one parameter from the at least one acoustic sensor, wherein the sensor output data for the at least one radar sensor is used to determine which areas of the terrain ahead of the vehicle the acoustic sensors need to interrogate in greater detail once they become within range of the acoustic sensors.

17. A memory means containing a computer readable code for performing the method according to claim 16.

18. A vehicle comprising a system as claimed in claim 1, including at least one radar transmitting antenna for transmitting an radar signal to the terrain ahead and at least one radar receiving antenna for receiving a reflected signal of the radar signal from the terrain ahead, and at least one acoustic transmitter for transmitting an acoustic signal to the terrain ahead and at least one acoustic receiver for receiving a reflected signal of the acoustic signal from the terrain ahead.
